(19) United States
(12) Patent Application Publication
(10) Pub. No.: US 2005/0218123 A1
(43) Pub. Date: Oct. 6, 2005

(54) Laser welding method of resin materials

(76) Inventors: Tsuyoshi Hayakawa, Kariya-city (JP); Yasunori Kawamoto, Toyota-city (JP)

Correspondence Address: HARNESS, DICKEY & PIERCE, P.L.C., P.O. BOX 828, BLOOMFIELD HILLS, MI, 48303, US

(21) Appl. No.: 11/097,926

(22) Filed: Apr. 1, 2005

(30) Foreign Application Priority Data
Apr. 1, 2004 (JP) 2004-109030

(51) Int. Cl. B23K 26/00

(52) U.S. Cl. 219/121.64

(57) ABSTRACT

When an absorptive material 1 having a high absorption factor to a laser beam L and a transmissible resin material 2 having a high transmission factor to the laser beam are lapped one upon another and the laser beam is irradiated to the joint portion through the transmissible resin material to fuse the joint portion and to weld both of the resin materials, a laser welding method of the invention disposes a protuberance 5 on the contact side of the absorptive resin material with the transmissible resin material, and irradiates and scans the laser beam along a weld line M while both of the resin materials are kept pressed by using a jig 3 or the like. The sectional shape of the protuberance is a triangle, a rectangle or a trapezoid. Consequently, the invention can improve an initial surface pressure, can reduce a clearance and can provide a weld portion 9 devoid of defects, such as voids, resulting from the entrapment of air.

### BACKGROUND OF THE INVENTION

1. Field of the Invention

This invention relates to a laser welding method of resin materials for welding a resin material having transmissibility to a laser beam and a resin material having absorptivity to the laser beam by placing them one upon another and irradiating a laser beam to the joint portion.

2. Description of the Related Art

A lap welding method of resin materials by using a laser beam that places a resin material having transmissibility to a laser beam and a resin material having absorptivity one upon another, irradiates a laser beam to the joint portion through the transmissible resin material to cause exothermy in the absorptive resin material and fuses the joint portion by this heat to fuse them together has been known in the past.

Such a welding technology of the resin materials by the laser beam is expected to make great contributions to the reduction in size of products, reduction of production cost and high reliability with a decrease in the laser cost.

According to the prior art technology, the transmissible resin material and the absorptive resin materials as two resin molded materials are pressed by a support jig while they are kept in the lapped state and the laser beam is irradiated through the transmissible resin material to fix them to each other. In other words, the transmissible resin material 2 is lapped on the absorptive resin material 1 and both are then pressed by the pressing jig 3 as shown in FIG. 9. The laser beam L is irradiated, under this state, from an optical head 4 from the side of the transmissible resin material 2. The laser beam transmitting through the transmissible resin material 2 irradiates the absorptive resin material 1 to cause exothermy and to mutually deposit the absorptive resin material 1 and the transmissible resin material. Therefore, welding is carried out by irradiating the laser beam L while clearances 5 occur due to warpage and sink mark at the time of resin molding as shown in FIG. 9. Because the movement of heat cannot be done efficiently, a weld portion 9 has non-welded portions 6 and voids 7 formed by the entrapment of air.

The laser welding method according to the prior art technology is not yet free from the following problems.

(1) Clearances 5 are formed due to warpage and sink mark at the time of resin molding when the two resin materials are lapped with each other and non-welded portions and voids occur due to entrapment of air.

(2) Unless a weld width has a certain width, the strength of the weld portion drops and durability cannot be secured.

(3) An initial surface pressure cannot be secured when the contact area is great during pressing by using the support jig, etc.

(4) A jig structure gets complicated when the pressurization force is increased to secure the initial surface pressure.

Therefore, Japanese Unexamined Patent Publication Nos. 2000-294013 and 2001-334578, for example are known as prior art that improves the joint shape between both resin materials. According to this patent reference of No. 2000-294013, a seal leg is allowed to protrude from a front surface lens as the transmissible resin material, a distal end face of this seal leg is brought into contact with a reception surface of a lamp body as the absorptive resin material, and both are welded by irradiating the laser beam to the reception surface through the seal leg. Japanese Unexamined Patent Publication No. 2001-334578 forms a lens optical path for condensing the laser, having a protruding shape in the transmissible resin material on the laser irradiation side so that a beam diameter is a minimum at the interface between the transmissible resin material and the absorptive resin material.

However, both patent references form the protuberance portion in the transmissible resin material so as not to reduce the energy of the laser beam or provide the lens operation to the protuberance portion to condense the laser beam. In other words, these technologies depend exclusively on transmissibility of the laser beam on the side of the transmissible resin material and involve the problem that heat movement from the absorptive resin material on the exothermic side cannot be done efficiently.

### SUMMARY OF THE INVENTION

The present invention provides a laser welding method of resin materials that improves an initial surface pressure of both resin materials, reduces a clearance by pressing, compulsively eliminates the clearance between both resin materials by sinking the resin material into the melted resin material during welding, can secure excellent quality and can thus stably provide a firm weld portion.

When an absorptive resin material having a high absorption factor to a laser beam and a transmissible resin material having a high transmission factor to the laser beam are lapped one upon another and the laser beam is irradiated to the joint portion through the transmissible resin material to fuse the joint portion and to weld both of the resin materials, a laser welding method of the present invention disposes a protuberance on the contact side of the absorptive resin material with the transmissible resin material, and irradiates and scans the laser beam while both of the resin materials are kept under pressure. Consequently, the initial surface pressure can be improved and the clearance between both resin materials can be reduced. The clearance can be compulsively eliminated by fusing the distal end of the protuberance during welding and a firm weld portion can be stably obtained.

The laser welding method according to the present invention can select the sectional shape of the protuberance disposed on the surface of the absorptive resin material from any of a triangle, a rectangle and a trapezoid. In other words, the sectional shape of the protuberance can be selected in accordance with characteristics of the weld portion. To obtain a weld portion requiring a tensile strength or a sunk amount, for example, the triangle is selected for the sectional shape of the protuberance. To obtain a weld portion requiring a weld width, a rectangle or a trapezoid can be selected for the sectional shape of the protuberance.

In the laser welding method according to the present invention, when the sectional shape of the protuberance is triangular, two protuberances may be disposed. In this case, a weld portion suitably satisfying the three factors, that is, the sunk amount, the tensile strength and the weld width, can be obtained.

The present invention may be more fully understood from the description of preferred embodiments of the invention, as set forth below, together with the accompanying drawings.

### BRIEF DESCRIPTION OF THE DRAWINGS

In the drawings:

FIG. 1 explains a laser welding method according to an embodiment of the invention;

FIG. 2 shows a joint according to a prior art example (10) and a sectional shape (joint shape) of a protuberance in each of examples 11 to 20 of the invention;

FIG. 3 is a graph showing the relation between an initial surface pressure and a sunk amount in the prior art example 10 and in each Example 11 to 20 of the invention;

FIG. 4 is a graph showing the relation between protuberance angle and the sunk amount in the prior art example 10 and in each Example 11 to 20 of the invention;

FIG. 5 is a graph showing the relation between the initial surface pressure and a weld width in the prior art example 10 and in each Example 11 to 20 of the invention;

FIG. 6 is a graph showing the relation between the protuberance angle and the weld width in the prior art example 10 and in each Example 11 to 20 of the invention;

FIG. 7 is a graph showing the relation between the initial surface pressure and a tensile strength in the prior art example 10 and in each Example 11 to 20 of the invention;

FIG. 8 is a graph showing the relation between the protuberance angle and the tensile strength in the prior art example 10 and in each Example 11 to 20 of the invention; and

FIG. 9 explains a laser welding method according to the prior art.

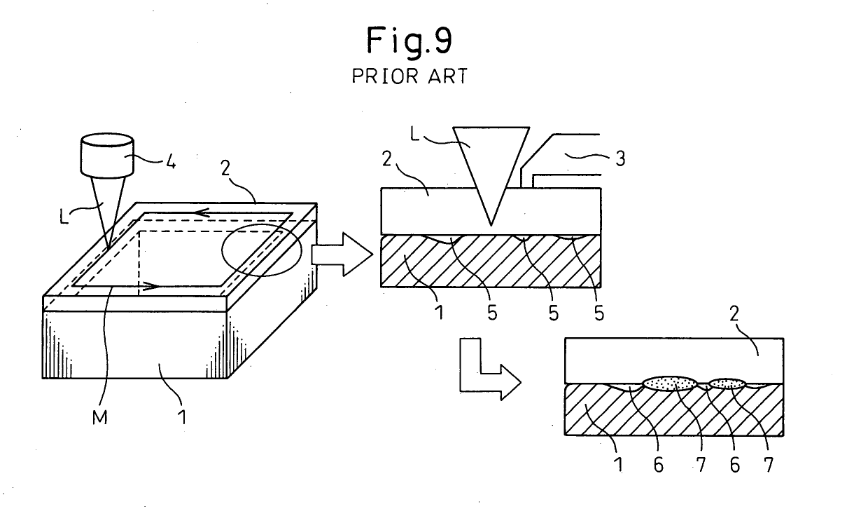

### DESCRIPTION OF THE PREFERRED EMBODIMENTS

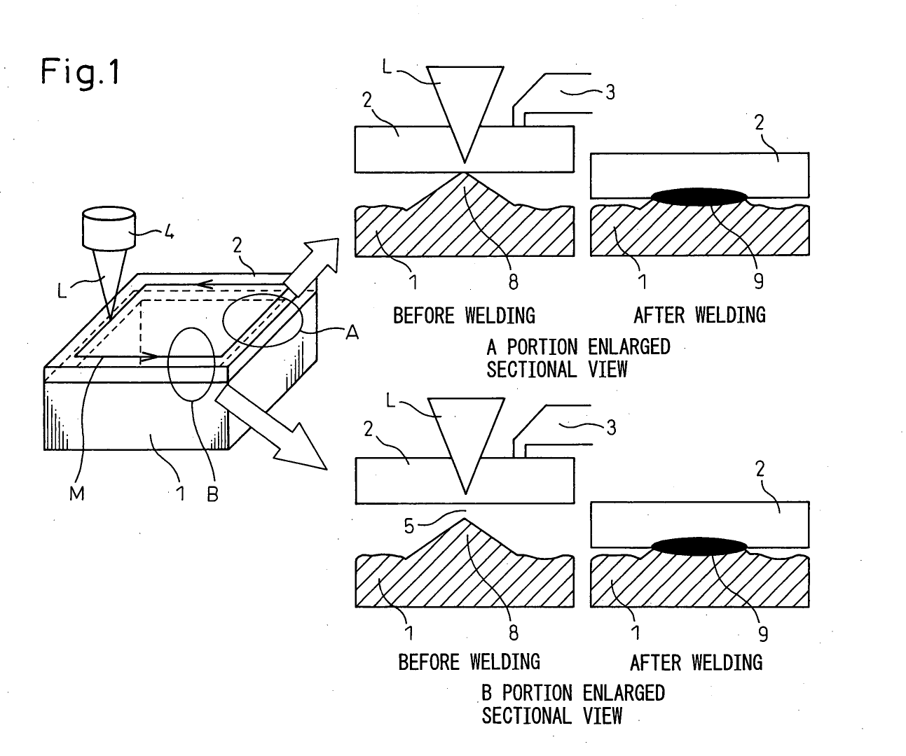

A laser welding method according to an embodiment of the invention will be hereinafter explained with reference to the accompanying drawings. FIG. 1 explains the laser welding method of the embodiment. Reference numeral 1 denotes an absorptive resin material having high absorptivity to a laser beam and reference numeral 2 denotes a transmissible resin material having high transmissibility to the laser beam. Both resin materials 1 and 2 are lapped one upon another so that the transmissible resin material exists on the irradiation side of the laser beam. Both resin materials 1 and 2 so lapped are pressed by a support jig (pressurization jig) 3 and are set and held on a table (not shown in the drawing). Generally, this table can move in both X- and Y-axes directions and can rotate in an X-Y plane.

Reference numeral 4 denotes an optical head for irradiating the laser beam L. The laser beam L generated by a laser generator, not shown, and passing through an optical fiber is irradiated from the optical head 4 to the resin materials. The optical head 4 is held by a robot, or the like, not shown in the drawing, and the irradiation angle of the laser beam L and its irradiation position can be changed. The optical head 4 can be moved in some cases in the X- and Y-axes directions. Therefore, scanning of the laser beam L can be made by moving the optical head 4 side or by moving the table side holding both resin materials 1 and 2.

A protuberance 8 as a feature of the invention is disposed on the contact side of the absorptive resin material 1 with the transmissible resin material 2. This protuberance 8 is disposed in such a manner as to be substantially coincident with a weld line M scanned by the laser beam L indicated by arrows in FIG. 1. In FIG. 1, therefore, the protuberance 8 is formed into a rectangular shape on the surface of the absorptive resin material 1 and its sectional shape is a triangle.

FIG. 1 shows the conditions before and after welding of portions A and B in enlarged sectional views. In other words, the enlarged sectional view of the portion A shows the condition before welding where the pressing force is applied by the support jig 3 and both resin materials are brought into mutual contact while the distal end of the protuberance 8 of the absorptive resin material 1 is crushed without forming a clearance 5. The protuberance 8 of the absorptive resin material 1 thereafter starts fusing with the irradiation of the laser beam L and the transmissible resin material 2 starts sinking. Finally, the protuberance 8 disappears substantially completely and the absorptive resin material 1 and the transmissible resin material 2 are welded to each other. In this case, air between both resin materials 1 and 2 is exhausted in such a manner as to flow down along the slope of the protuberance 8 and a weld portion 9 devoid of defect is acquired without forming voids resulting from entrapment of air.

At the portion B, on the other hand, the protuberance 8 of the absorptive resin material 1 and the transmissible resin material 2 do not come into mutual contact before welding due to warpage and sink mark formed during molding of the resin materials, thereby forming the clearance 5 even though the pressurization force is applied by the support jig 3. The protuberance 8 of the absorptive resin material 1 thereafter starts fusing with the irradiation of the laser beam L and the transmissible resin material 2 starts sinking. Finally, the protuberance 8 disappears substantially completely and the absorptive resin material 1 and the transmissible resin material 2 are welded to each other. In this case, too, air between both resin materials 1 and 2 is exhausted in such a manner as to flow down along the slope of the protuberance 8 and the occurrence of defect such as voids due to entrapment of air can be prevented at a weld portion 9.

The absorptive resin material 1 having a high absorption factor of the laser beam L is not particularly limited so long as it has thermo-plasticity, does not transmit the laser beam but can absorb the same. For example, it is possible to use mixtures of resin materials such as polyamide (PA), polyethylene (PE), polypropylene (PP), polycarbonate (PC), polyoxymethylene (POM), acrylonitrile-butadiene-styrene (ABS), polybutylene terephthalate (PB), polyphenylene sulfide (PPS), acryl (PMME), etc, with predetermined colorants such as dyes and pigments.

The transmissible resin material 2 having a high transmission factor of the laser beam is not particularly limited so long as it has thermo-plasticity and a predetermined transmission factor to the laser beam L. Basically, it is possible to use the resin materials described above. Colorants may be mixed, as well, so long as a predetermined transmission factor can be secured.

Incidentally, reinforcing fibers such as a glass fiber and a carbon fiber may be added to both absorptive resin material 1 and transmissible resin material 2, whenever necessary.

As to the combination of the absorptive resin material 1 and the transmissible resin material 2, the combination of mutually compatible resins is suitable. Such a combination may include the combination of different kinds of resins besides the combination of the same kind of resin.

As to the kind of the laser beam L used as the heating source, the laser beam having a wavelength that exhibits a predetermined value of the transmission factor inside the transmissible resin is appropriately selected in connection with the absorption spectrum and a sheet thickness (transmission length) of the transmissible resin transmitting the laser beam L. For example, it is possible to use YAG laser, semiconductor laser, glass-neodymium laser, ruby laser, helium-neon laser, krypton laser, argon laser, hydrogen laser, nitrogen laser, and so forth.

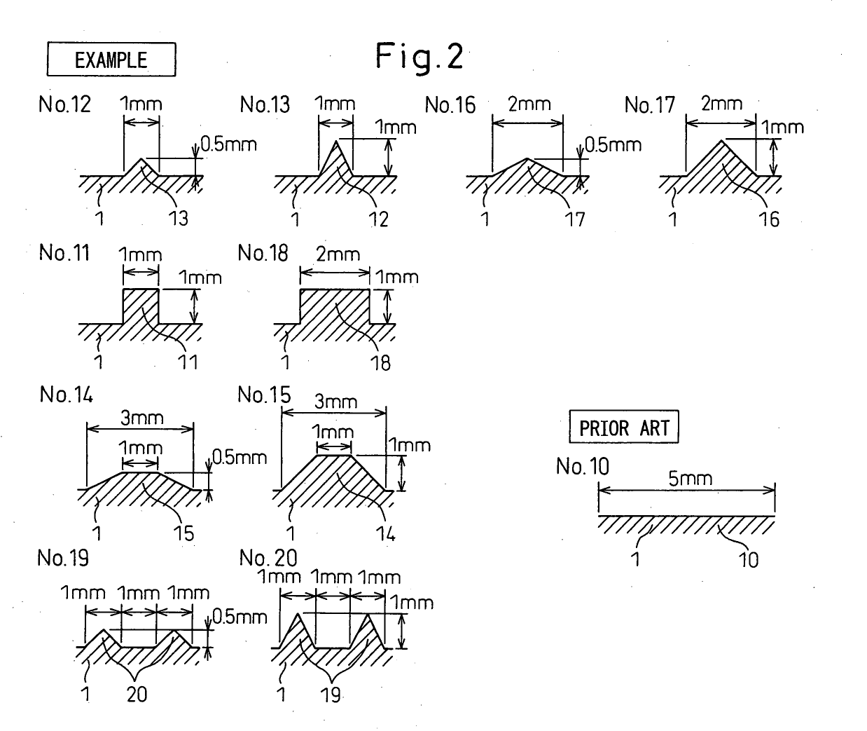

In the invention, the sunk amount, the weld width, the tensile strength, etc, are measured by using various shapes of the protuberances 8 (joint shapes) provided to the absorptive resin material 1. FIG. 2 shows the sectional shape of the protuberance 8 (joint shape) in each Examples 11 to 20. Incidentally, reference numeral 10 represents a flat joint shape in the prior art example not having the protuberance 8 in the prior art example.

Examples 12, 13, 16 and 17 represent the case where the sectional shape of the protuberance 8 (joint shape) is a triangle. Examples 11 and 18 represents the case where the sectional shape of the protuberance 8 (joint shape) is a rectangle. Examples 14 and 15 represent the case where the sectional shape of the protuberance 8 (joint shape) is a trapezoid. Examples 19 and 20 represent the case where two protuberances 8 having a triangular sectional shape are disposed.

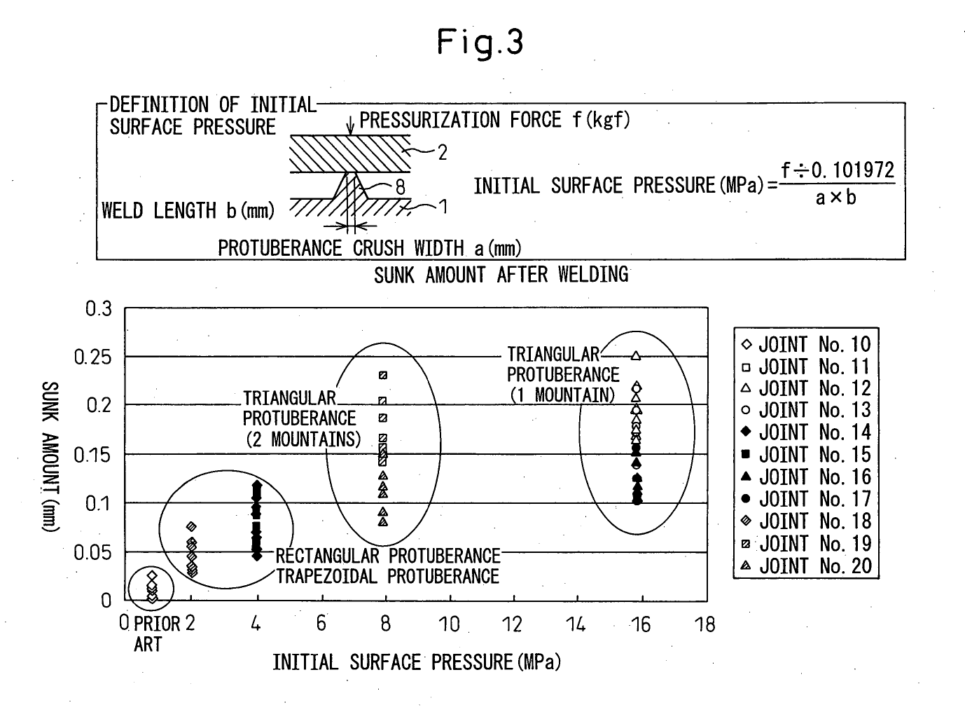

FIG. 3 comparatively shows the relation between the initial surface pressure (MPa) and the sunk amount (mm) in the prior art example 10 and Examples 11 to 20. In this case, the initial surface pressure is determined in accordance with the following equation:
Initial surface pressure (MPa)=f÷0.101972/(a×b)

In the equation given above, f (kgf) represents the pressurization force, (a) (mm) represents the protuberance crush width and (b) (mm) represents the weld length.

The equation of the initial surface pressure is the equation that is generally used. In other words, the initial pressure (MPa)=N/area (mm²) and N is given by N=whole pressurization force (kgf)÷0.01972. The area (mm²) is given by area=a (mm)×b (mm). This area represents the contact area between the transmissible resin material and the absorptive resin material at the time of pressurization. The equation of the initial surface pressure given above can be determined from these parameters.

As shown in FIG. 3, the initial surface pressure and the sunk amount are large in Examples 12, 13, 16 and 17 having one triangle (one mountain). In Examples 19 and 20 having two triangles (two mountains), the initial surface pressure drops to a half though the sink amount is substantially equal to the case of one triangle. In Examples 11, 18 and 14 and 15 having rectangles and trapezoids, both sunk amount and initial surface pressure are much smaller than in the case of the triangle but are higher than that of the prior art example 10.

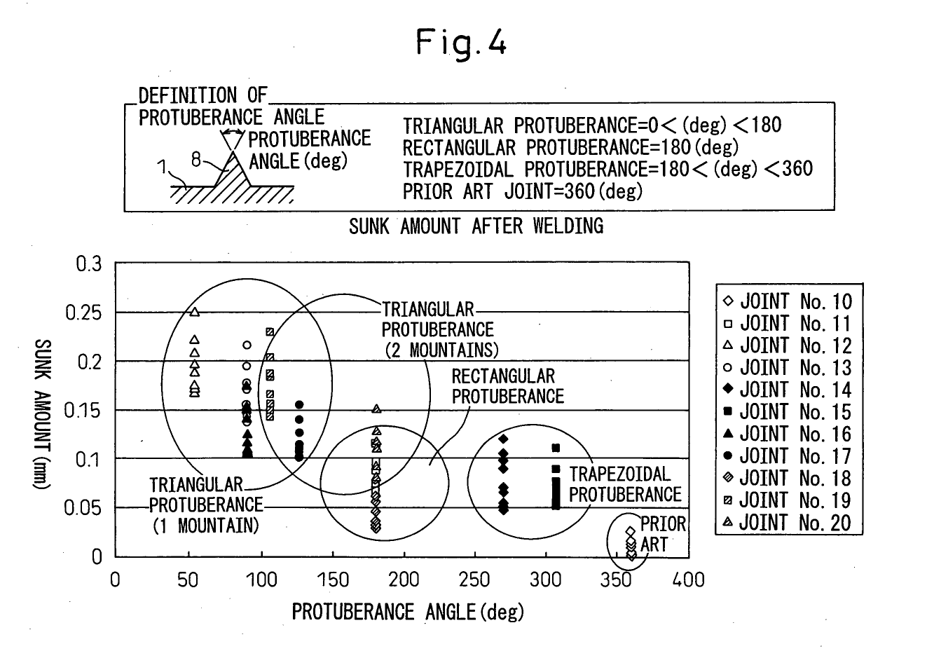

FIG. 4 comparatively shows the relation between the protuberance angle (deg) and the sunk amount (mm) in the prior art example 10 and Examples 11 to 20. In this case, the protuberance angle (deg) of the triangular sectional shape satisfies the relation 0<protuberance angle (deg)<180, the protuberance angle of the rectangle is 180 (deg) and the protuberance angle of the trapezoid satisfies the relation 180<protuberance angle (deg)<360. The protuberance angle (deg) of the prior art example 10 is 360 (deg).

As a result, the sink amount (mm) becomes greater in the order of one triangle (Examples 12, 13, 16, 17), two triangles (Examples 19 and 20), the rectangle (Examples 11 and 18) and the trapezoid (Examples 14 and 15) and is the smallest in the case of the prior art example 10.

The acuter the protuberance angle of the triangle, the greater becomes the sunk amount.

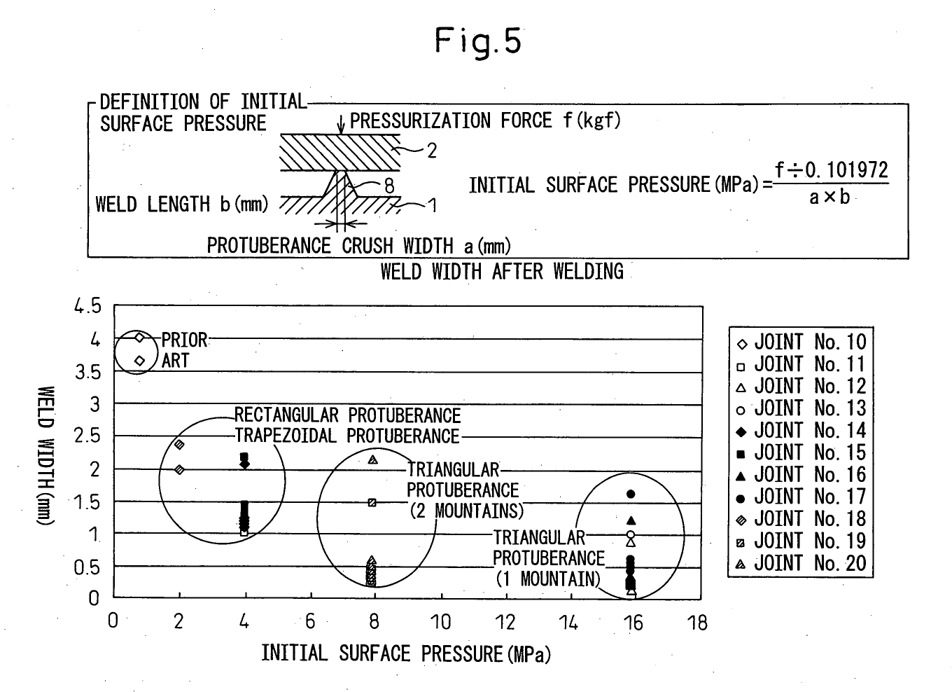

FIG. 5 comparatively shows the relation between the initial surface pressure (MPa) and the weld width (mm) in the prior art example 10 and Examples 11 to 20. In this case, the weld width becomes smaller when the initial surface pressure is greater. In other words, as shown in FIG. 5, the initial surface pressure (MPa) becomes greater in the order of one triangle (Examples 12, 13, 16 and 17), two triangles (Examples 19 and 20), the rectangle and the trapezoid (Examples 11, 18, 14, 15) and in the prior art example, and the weld width (mm) changes from small to great.

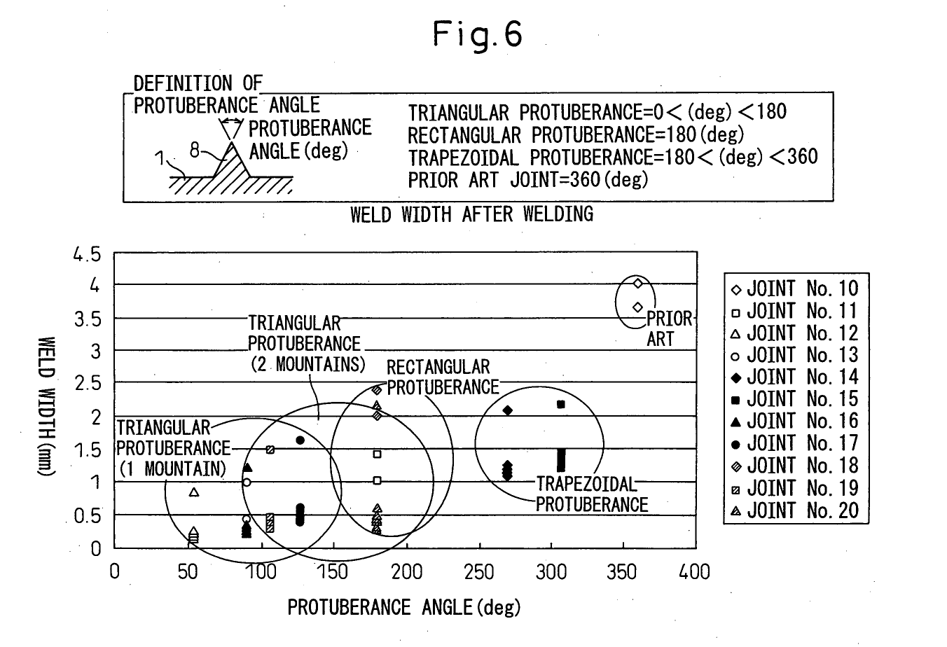

FIG. 6 comparatively shows the relation between the protuberance angle (deg) and the weld width (mm) in the prior art example 10 and Examples 11 to 20. The protuberance angle is defined in the same way as described above. In this case, the weld width becomes smaller in the order of the prior art example 10, the trapezoid (Examples 14 and 15), the rectangle (Examples 11 and 18), two triangles (Examples 19 and 20) and one triangle (Examples 12, 13, 16 and 17).

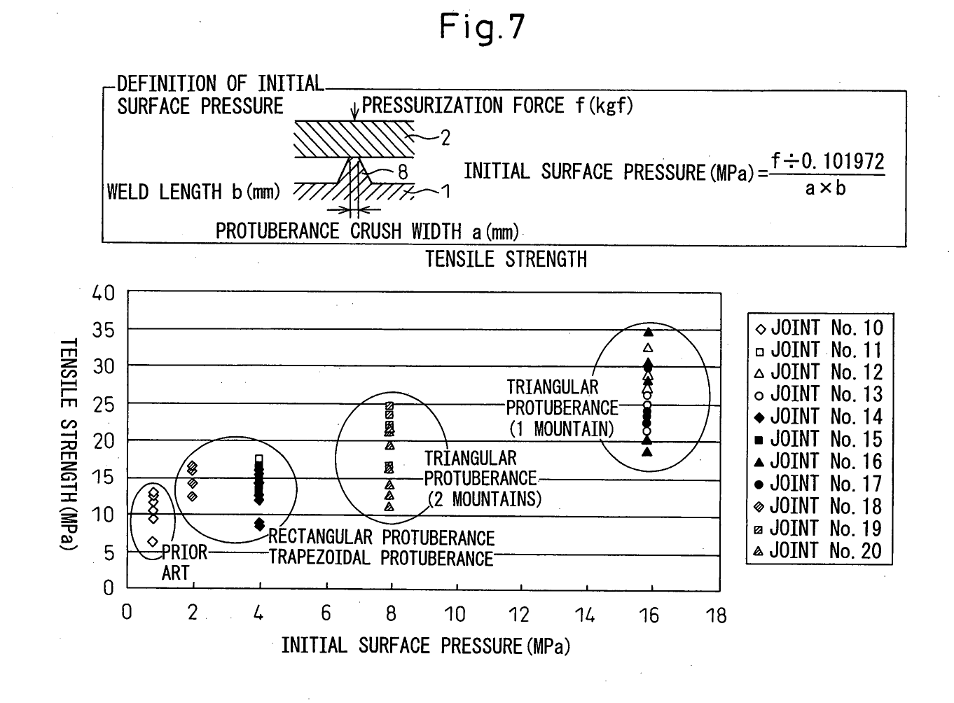

FIG. 7 comparatively shows the relation between the initial surface pressure (MPa) and the tensile strength (MPa) in the prior art example 10 and Examples 11 to 20. It can be understood that the tensile strength becomes higher when the initial surface pressure becomes higher in this case. In other words, as shown in FIG. 7, the tensile strength changes from great to small in the order of one triangle (Examples 12, 13, 16 and 17), two triangles (Examples 19 and 20), the rectangle and the trapezoid (Examples 11, 18, 14 and 15) and the prior art example 10.

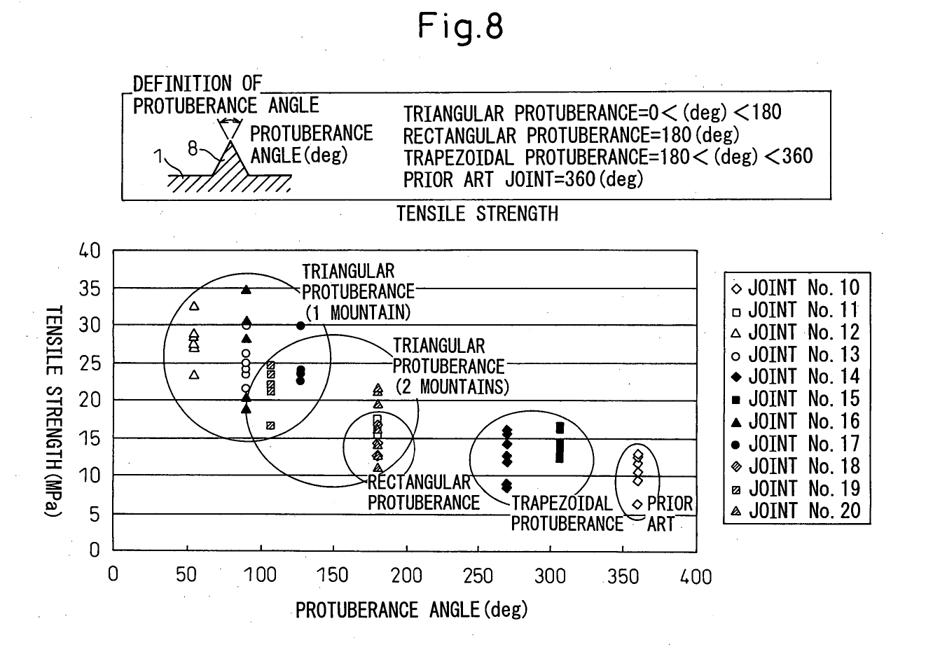

FIG. 8 comparatively shows the relation between the protuberance angle (deg) and the tensile strength (MPa) in the prior art example 10 and Examples 11 to 20. It can be understood from FIG. 8 that the tensile strength becomes gradually higher in the order of the prior art example 10, the trapezoid (Examples 14 and 15), the rectangle (Examples 11 and 18) and two triangles (Examples 19 and 20), one triangle (Examples 12, 13, 16 and 17).

It can be understood from the measurement results shown in FIGS. 3 to 8 that the sectional shape of the protuberance 8 (joint shape) must be selected in accordance with the requirements for the weld portion.

When the clearance is great as in a large casing, the protuberance having a high initial surface pressure and a triangular sectional shape is preferably used as shown in FIG. 3. In such a case, a greater effect can be obtained by selecting a triangle having an acuter angle as shown in FIG. 4. The protuberance having such a triangular sectional shape has a pressure gradient effect due to the sunk amount and purges staying air between both resin materials.

When it is necessary to secure a reliable weld width so as to secure durability of the weld portion, the protuberance having a rectangular sectional shape shown in FIGS. 5 and 6 is preferably used. However, when the weld width is one that exceeds a certain level (1.0 mm or more, for example), the protuberance partly having a triangular sectional shape can be used, too.

When the strength of the weld portion is required, the protuberance having the triangular sectional shape is the best as shown in FIGS. 7 and 8.

Excellent weld quality satisfying each requirement for the weld portion can thus be secured by appropriately selecting the sectional shape of the protuberance (joint shape) in consideration of the three parameters, that is, the sunk amount, the weld width and the tensile strength.

As explained above, the laser welding method according to the invention can easily correct the clearance between the resin materials that has been the problem in the past, can remarkably improve the strength of the laser weld portion, and can make not only hermetic bonding of cases but also strong bonding of important portions for a product structure, and can drastically increase the range of applications of laser welding besides automobile components such as instrumental panels, electric/electronic components such as battery cases, and so forth.

While the invention has been described by reference to specific embodiments chosen for purposes of illustration, it should be apparent that numerous modifications could be made thereto, by those skilled in the art, without departing from the basic concept and scope of the invention.

1. A laser welding method of resin materials involving the steps of lapping an absorptive material having a high absorption factor to a laser beam and a transmissible resin material having a high transmission factor to the laser beam one upon another, irradiating the laser beam to the joint portion through said transmissible resin material, fusing the joint portion and welding both of said resin materials, wherein a protuberance is disposed on the contact side of said absorptive resin material with said transmissible resin material, and the laser beam is irradiated and scanned while both of said resin materials are kept pressed by using a jig, or the like.

2. A laser welding method of resin materials as defined in claim 1, wherein a sectional shape of said protuberance is a triangle, a rectangle or a trapezoid.

3. A laser welding method of resin materials as defined in claim 1, wherein two of said protuberances are disposed when the sectional shape of said protuberance is a triangle.
